(19) United States
(12) Patent Application Publication
(10) Pub. No.: US 2026/0046309 A1
(43) Pub. Date: Feb. 12, 2026

(54) SYSTEMS, DEVICES, ARTICLES, AND METHODS FOR PROTECTION FROM PHISHING ATTACKS

(71) Applicant: Stingray Security Ltd., Vancouver (CA)

(72) Inventor: Ian MacKinnon, Vancouver (CA)

(73) Assignee: Stingray Security Ltd., Vancouver (CA)

(21) Appl. No.: 19/294,036

(22) Filed: Aug. 7, 2025

Related U.S. Application Data
(60) Provisional application No. 63/680,874, filed on Aug. 8, 2024.

(51) Int. Cl. H04L 9/40; G06F 40/103

(52) U.S. Cl. CPC H04L 63/1483; G06F 40/103; H04L 63/0428

(57) ABSTRACT

Embodiments of the present disclosure relate to systems, devices, articles, and methods providing protection against phishing and thereby protecting sensitive information of a user or organization. The system receives a user request and document object model from a user interface device comprising details of the webpages. The system checks if the webpage contains a first part characterized by an input field to enter sensitive information and obscures the first part on the webpage if present. The system renders or displays the remaining part of the webpage.

### TECHNICAL FIELD

The disclosure generally relates to information security and anti-phishing systems, devices, articles, and methods. More particularly, the disclosure relates to protection against phishing attacks by obscuring fields used to input sensitive information.

### BACKGROUND

The purpose of the following description of related art is solely to provide background information pertaining to the relevant field of the disclosure. Note this section is only to enhance the understanding of the reader with respect to the present disclosure. Therefore, unless otherwise indicated, it should not be assumed that any information described in this section qualifies as prior art merely by inclusion in this section.

Presently, fraudulent, or phishing websites deceive users into disclosing personal information and credentials. Attackers can collect sensitive data through these sites and later misuse it to the user's disadvantage. Phishing poses a major issue, not only because of the fraud involved but also because it challenges trust in online transactions and complicates online communications.

The conventional anti-phishing techniques focus on filtering and marking suspect messages as spam as well as blocking or gating the entire webpage. Blocking includes placing the webpage behind a firewall, and gating includes a user accepting the risk of visiting a webpage without review.

### SUMMARY

This section is intended to introduce certain objectives and aspects of the present disclosure in a simplified manner. The disclosure relates to a method of operation in a system for protection against phishing attacks. The system includes at least one processor and a user interface device in communication with the at least one processor. The method comprises receiving, by the at least one processor, a document object model characterizing a webpage; detecting, by the at least one processor, within the document object model if the webpage contains a first part, wherein the first part is an input field to enter sensitive information; and if the webpage includes the first part, obscuring, by the at least one processor, the first part from a rendering of the webpage based on the document object model, wherein the rendering is suitable for display on the user interface device. In some embodiments, the method comprises receiving, by the at least one processor from the user interface device, a request to display the webpage; intercepting the request to display the webpage on the user interface device; and checking the webpage for one or more suspicious activities if the webpage includes the first part, wherein the one or more suspicious activities are previously reported or new.

In other embodiments, the disclosure relates to a method of operation in a system including at least one processor, and a non-transitory processor-readable storage device in communication with the at least one processor. The method comprises installing on the non-transitory processor readable storage device, processor-executable instructions which when executed by the at least one processor, cause the at least one processor to receive a document object model characterizing a webpage; detect within the document object model if the webpage contains a first part, wherein the first part is an input field to enter sensitive information; and if the webpage includes the first part, obscure the first part from a rendering of the webpage based on the document object model, wherein the rendering is suitable for display on the user interface device.

Further, the embodiments of the present disclosure encompass a system for protection against phishing attacks. The system comprises a user interface device, wherein the user interface device is processor-based. The system also comprises at least one processor communicatively coupled to the user device; and at least one non-transitory processor-readable storage device communicatively coupled to the at least one processor and which stores processor-executable instructions which, when executed by the at least one processor, cause the at least one processor to receive a document object model characterizing a webpage, detect within the document object model if the webpage contains a first part, wherein the first part is an input field to input sensitive information, and if the webpage includes the first part, obscure the first part from a rendering of the webpage based on the document object model, wherein the rendering is suitable for display on the user interface device.

In some embodiments, the at least one processor checks the webpage for one or more suspicious activities if the webpage includes the first part, wherein the one or more suspicious activities are previously reported or new. In other embodiments, the at least one processor displays the webpage in the web browser and intercepts a request to display the webpage in the web browser included in the user interface device.

This summary does not necessarily describe the entire scope of all aspects of the disclosure. Other aspects, features, and advantages will be apparent to those of ordinary skill in the art upon review of the following description of specific embodiments.

### BRIEF DESCRIPTION OF DRAWINGS

Systems, devices, and methods are described in greater detail herein with reference to the following figures in which:

FIG. 1 illustrates, in a schematic view, a system architecture including a plurality of circuits.

FIG. 2 illustrates, in a schematic view, a user interface device including various components working together.

FIG. 3 illustrates an exemplary screenshot of a first example of obfuscation of a first part of a webpage wherein the first part is blurred.

FIG. 4 illustrates an exemplary screenshot of a second example of obfuscation of the first part of a webpage wherein the first part is covered.

FIG. 5 illustrates an exemplary screenshot of a third example of obfuscation of the first part of the webpage wherein the first part is omitted.

FIG. 6 illustrates an exemplary screenshot of a fourth example of obfuscation of the first part of the webpage wherein the first part is covered and a warning sign is displayed.

FIG. 7 illustrates an implementation of a method to obscure the first part of the webpage.

FIG. 8 illustrates an implementation of a method to obscure the first part of the webpage.

FIG. 9 illustrates an implementation of a method to obscure the first part of the webpage.

The above-mentioned drawings illustrate exemplary embodiments of the disclosed methods and systems in which like reference numerals refer to the same parts throughout the different drawings. Components in the drawings are not necessarily to scale, as emphasis is placed on clearly illustrating the principles of the inventions. Some drawings may use block or schematic diagrams and thus represent without showing details such as internal circuitry of components. Also, the embodiments shown in the figures are not to be construed as limiting the inventions but only as illustrative examples of an automated method and system according to the inventions that are illustrated herein to highlight the advantages of the inventions.

### DETAILED DESCRIPTION OF THE INVENTION

When entire webpages or large sections are hidden the anti-phishing protection overreaches. The user is unable to determine what is happening—e.g., cannot provide feedback, or report an attack is happening. It also provides no evidence for the user to calibrate their suspicion. Therefore, conventional techniques are unable to efficiently protect users from these phishing attacks. Also, the block lists are overly cautious by blocking entire webpages and erring on the side of blocking or gating. The current processes are time-consuming and slow—often a webpage is blocked only after evidence is gathered and the damage is already done. Herein the applicants share different systems, devices, articles and methods.

In the following description, associated drawings, included claims, and other parts of the document, various details are set forth to provide a detailed understanding of the disclosure and embodiments thereof. It will be apparent, however, that the disclosed embodiments may be practiced without some of these details. Several features described hereafter can each be used independently of one another or in combination with other features.

Hence, in view of the above-mentioned problems and challenges, the Applicant appreciates there is a need for an efficient system and method for efficient anti-phishing techniques to protect sensitive information (e.g., user-sensitive information) while maintaining the usability and transparency of the rest of the webpage.

Embodiments of the present disclosure relate to a system and a method for ensuring user security and protecting user's sensitive information on any webpage. When a user visits a webpage, the system detects within the document object model if the webpage contains a first part, wherein the first part is an input field to enter the user's sensitive information. If the webpage includes the first part asking the user to enter the sensitive information, the system protects the user from phishing by obscuring the first part and simultaneously rendering the other parts of the webpage. The system also checks for one or more suspicious activities in such cases. Obscuring the first part from the rendering of the webpage provides protection against phishing attacks.

As used herein, the webpage is a document viewed in a web browser, such as Chrome, Firefox, or Safari. The webpage is typically written in hypertext (HTML) and can include text, images, videos, and links to other webpages. Each webpage has a unique address called a URL (Uniform Resource Locator) which can be entered in the browser's address bar for access. In this disclosure, the first part of the webpage refers to that section asking for the user's sensitive information while the other parts or sections of the webpage are referred to as remaining parts. Further, for clarity, it is explained herein that a website is a set of webpages under a common domain like ‘www.example.com,’ whereas a webpage is a single page within the website, such as ‘www.example.com/contact. The terms “web page” and “webpage” refer to similar interpretations. Similarly, the terms “web site” and “website” refer to similar interpretations.

As used herein, “suspicious activities” indicate potential security issues or malicious intent. The common indicators for suspicious activities include unexpected redirects, browser warnings, spam pages, phishing attempts, and any such signs as may be obvious to a person skilled in the art. Some examples include a domain pretending to be from a popular domain (e.g., email logins, bank sites, and delivery services); a domain being on an existing block list; a domain not being on a safe list; cloaking a webpage by rendering a different version of the webpage when requests come from different sources; having characteristics of known phishing packages (for example, cohering to profile of a phishing template or stock service offered online); the reputability of the web server host; and the age of the domain since registration (e.g., newly registered domains are often an indicia of a scam.).

As used herein, the document object model (DOM) is a programming interface for web documents. It includes a language-independent collection of information defining the logical structure of a document and how the document is accessed. Further, the document object model includes a tree structure where each node in the tree structure is an object representing a part of the document. It also allows programming languages such as JavaScript to interact with the document, thereby allowing a user to change the document's structure, style, and content

As used herein, to obscure at least at part of a webpage, certain parts (specifically the first part) of the document are made difficult to see, read, or understand to protect the sensitive information and ensure privacy. This can be achieved through multiple options such as Omission/Redaction: remove the first part so that it is not visible. Overlay: cover or block out the first part or replace the first part with other information (e.g., encrypted information, fake data that looks real, but it is not real), augment with a warning. Blur: make the part with sensitive information of low resolution or blurry so the user cannot easily read or recognize it.

As used herein, rendering refers to a process of converting the code (e.g., HTML, CSS, JavaScript) into visual and interactive web content. This can be achieved at the server side or user side.

As used herein, “sensitive information” refers to data that must be protected or hidden from unauthorized access to safeguard the privacy or security of individuals or organizations. Examples include Personally Identifiable Information (PII), health information, financial information, and business information. In some embodiments, sensitive information includes user-sensitive information. In some embodiments, user-sensitive information is selected from the group consisting of user login details, password, access credentials, authentication credentials, date of birth, code word, code phrase, banking information, payment information, credit card information, identification information, SIN number, passport number, authorization tokens and locations. The terms “sensitive information”, “user information”, “user-sensitive information” and “private information” refer to similar interpretations and may be interchangeably used throughout the specification.

The term “a” or “an” when used in conjunction with the terms “comprise”, “include”, “comprising”, or “including” in the claims or the specification may mean “one”, “one or more”, “at least one”, and “a plurality” unless the content dictates otherwise. Similarly, the word “another” means “additional” or “at least a second” unless the content clearly dictates otherwise. The terms “or” and “and/or” herein when used in association with a list of items means any one or more of the items may be selected from that list.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled or coupling, can indicate that two units or devices are directly connected to one another or indirectly coupled to one another through one or more intermediate elements or devices via an electrical element, electrical signal or a mechanical element depending on the particular context. For example, as used herein, the term connected can indicate that two components are directly connected to one another.

As used herein, “input”, “send”, “transfer”, “transmit”, “receive”, “output” and their cognate terms refer to sending and/or receiving information from one unit to another unit of the system, wherein said information refer to all the data mentioned in the disclosure and may or may not be modified before or after sending and receiving the information according to the desired requirements.

The I/O device(s) as used herein includes one or more user interface input devices, such as a display, a keyboard, a mouse, a microphone, and a camera. The one or more user interface input devices may be detachable. In some embodiments, the I/O device(s) includes one or more output devices, such as displays, speakers, and lights. In some embodiments, the I/O device(s) is a single light.

The processor may be any logic processing unit such as one or more microprocessors, central processing units (CPUs), digital signal processors (DSPs), graphics processing units (GPUs), application-specific integrated circuits (ASICs), programmable gate arrays (PGAs), programmed logic units (PLUs) or any such device as may be obvious to a person skilled in the art. The processor may include, but is not limited to, a processor or set of processors or any such processing unit as may be obvious to a person skilled in the art, which are configured to function in accordance with the one or more inventions described herein. The terms ‘processor’ and ‘processing unit’ may be interchangeably used throughout the specification.

The user interface device as used herein refers to a means by which the user and a computer system interact, in particular the use of input devices and software. The terms “user device” and “user interface device” refer to similar interpretations and may be interchangeably used throughout the specification.

The circuits as used herein refer to any components, units, hardware element, or any such unit as may be obvious to a person skilled in the art.

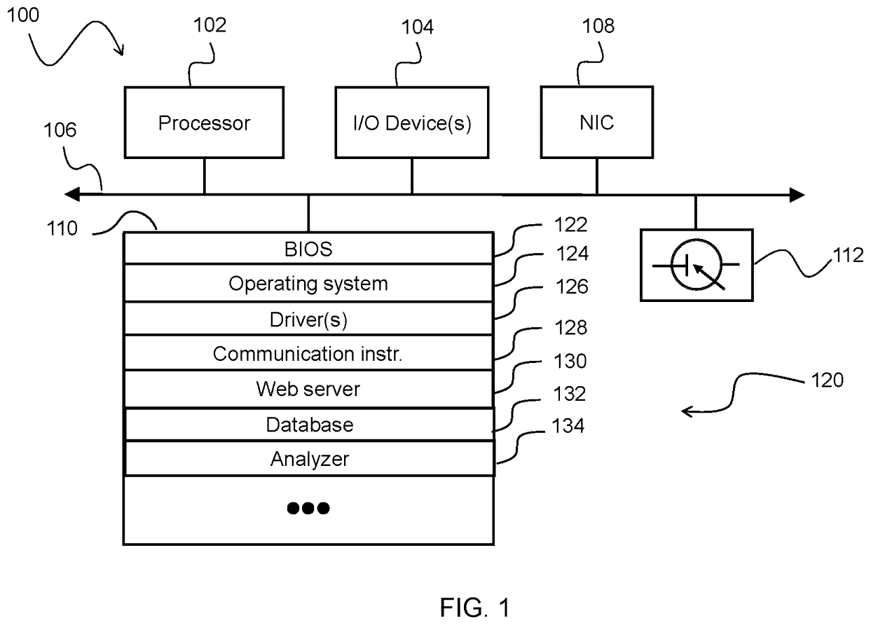

FIG. 1 illustrates a schematic view of aspects of a plurality of circuits 100 in accordance with some embodiments of the inventions. The plurality of circuits 100 includes a control subsystem comprising at least one processor 102, at least one input/output (I/O) subsystem 104, and at least one bus 106 to which, or by which, the at least one processor 102 and the I/O device(s) 104 are communicatively coupled.

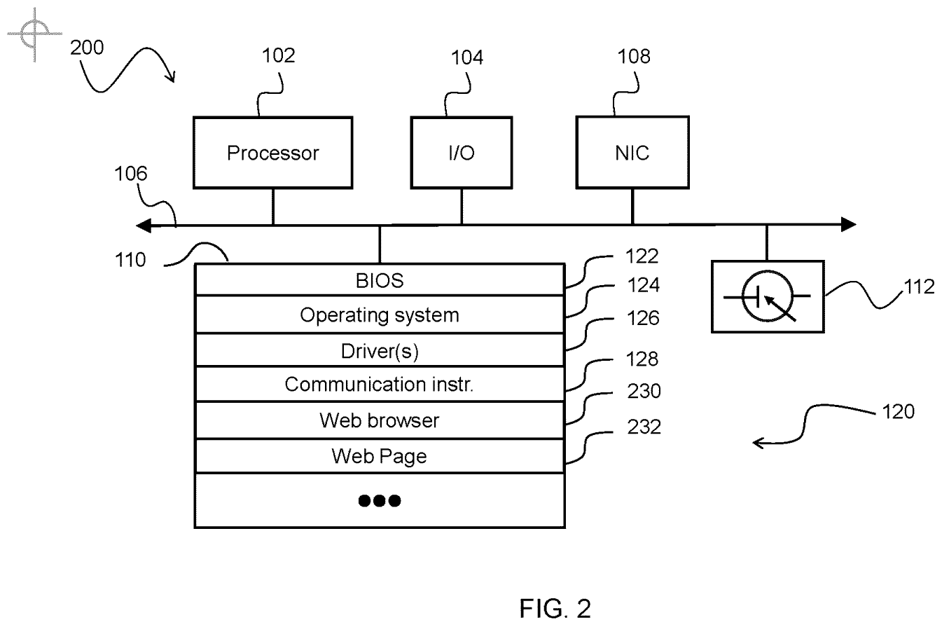

Further, the plurality of circuits 100 includes a Network Interface Card (NIC) or network interface subsystem 108 communicatively coupled to bus(es) 106, wherein the network interface subsystem 108 provides bi-directional communication to other components (e.g., a system external to the plurality of circuits 100) through one or more network or non-network communication channel(s) such as the internet. In some embodiments, the network interface subsystem 108 includes a circuitry. In other embodiments, the network interface subsystem 108 uses communication protocols (e.g., FTP, HTTP, Web Services, and SOAP with XML) for bidirectional communication of information including processor-readable data, and processor-executable instructions. In some embodiments, a user device 200 is communicatively coupled to the plurality of circuits 100, further described in relation to, at least, FIG. 2.

Furthermore, the plurality of circuits 100 includes at least one non-transitory computer or processor-readable storage device(s) 110 coupled to the bus(es) 106. The terms ‘non-transitory computer’ and ‘processor-readable’ may be interchangeably used throughout the specification. Further, storage device(s) 110 includes at least one non-transitory storage medium. In some embodiments, storage device(s) 110 includes two or more distinct devices, while in other embodiments, storage device(s) 110 includes one or more volatile storage devices (e.g., Random Access Memory (RAM)), and one or more non-volatile storage devices (e.g., Read Only Memory (ROM), flash memory, magnetic hard disk (HDD), optical disk, solid state disk (SSD), and the like). In some embodiments, processor-executable instructions are installed on the non-transitory storage device(s) 110. In some embodiments, storage device(s) 110 may be implemented in a variety of ways such as a read-only memory (ROM), random access memory (RAM), a hard disk drive (HDD), a network drive, flash memory, digital versatile disk (DVD) or any such forms as may be obvious to a person skilled in the art. Further, modern computer systems and techniques conflate volatile storage and non-volatile storage, for example, caching, using solid-state devices as hard drives, in-memory data processing, and the like.

Storage device(s) 110 may store on or within the included storage media processor-readable data and/or processor-executable instructions. Storage device(s) 110 include or store processor-executable instructions and/or processor-readable data 120 associated with the operation of the plurality of circuits 100, a plurality of aircraft, and the like. The terms “processor-executable instructions” and “processor-readable data” may be interchangeably used throughout the specification.

In some embodiments, the processor-executable instructions/data 120 include a Basic Input/Output System (BIOS) 122, an Operating System 124, driver(s) 126, communication instructions/data 128, a web server 130, a database 132, an analyzer 134 and the like. In an exemplary scenario, the operating system 124 is ANDROID®, LINUX®, WINDOWS® and the like. The driver(s) 126 include processor-executable instructions/data that allows the at least one processor 102 to control one or more components in the plurality of circuits 100. The processor-executable communication instructions/data 128 implements communications between the plurality of circuits 100 and another processor-based device through network interface subsystem 108.

The plurality of circuits 100 further includes one or more power supplies 112. In some embodiments, the power supply(ies) 112 are external power supply(ies), while in another embodiment, the power supply(ies) 112 are on-board power source(s) such as batteries, ultra-capacitors, or fuel cells, to independently power different components. In some embodiments, the processor-executable communication instructions/data 128, when executed, directs the plurality of circuits 100 to process input from I/O device(s) 104 or sensors included in a wider system, information that represents input stored on or in a storage device, such as storage device(s) 110. In some embodiments, the processor-executable communication instructions 128, when executed, direct the plurality of circuits 100 to communicate with each other.

In some embodiments, the database 132 includes information characterizing one or more input fields for sensitive information. The database 132 may include information characterizing one or more suspicious activities previously reported on a website or a webpage; HTML details, and the like. The database 132 may store and retrieve records from the webpage history.

Referring to FIGS. 1 and 2, the user interface device 200 transmits a request to the at least one processor 102 to display the webpage. For example, when the user intends to visit the webpage. In some embodiments, the request comprises a command to open a Uniform Resource Locator (URL), a protocol, the URL, and optionally request data and optional parameters. The URL can be a properly encoded URL, Uniform Resource Identifier (URI), or string. The protocol could be HTTP, HTTPS, FTP, or the like. The request data specifies additional data to be sent to the server. For example, a request to close the connection. In some embodiments, the optional parameters include and optional timeout parameter specifying a time to cease operations. In some embodiments, the optional parameters include a secret, or parameters specifying a set of certificates, a login credential, or the like. In some embodiments, the request to the at least one processor 102 to display the webpage is generated in response to a user clicking on a link or activating a resource, for example, in a chat message, document, email, MMS message, SLACK message SMS message, or text message.

A document object model is sent to the at least one processor 102 when the user of the user interface device 200 visits a webpage. In some embodiments, the web server 130, includes processor-executable instructions or data, which when executed, direct the plurality of circuits 100 to deliver content to devices (e.g., user interface devices) across a network (e.g., Internet). In some embodiments, the web server 130 includes a plurality of hosted files and instructions, which when executed, provides access to the hosted files. In some embodiments, the web server 130 includes an HTTP server that processes URLs (addresses) and HTTP (the protocol your browser uses to view webpages).

The analyzer 134 includes processor-executable instructions which, when executed, directs the plurality of circuits 100 to intercept the request and process the input from the web server 130 that represents the request and the document object model received from the user interface device 200. Further, analyzer 134, when executed, directs the plurality of circuits 100 to detect within the document object model if the webpage contains the first part. The first part is the input field to enter the sensitive information.

If the webpage includes the first part, the analyzer 134 obscures the first part from rendering (displaying) of the webpage based on the document object model, wherein the rendering is suitable for display on the user interface device 200. Therefore, the webpage is rendered from the document object model with the exception of the first part. In some embodiments, obscuring the first part from the rendering of the webpage includes at least one of blur, overlay, and omission of the first part of the webpage. In some embodiments, rendering comprises converting one or more parts of the document object model into a formatted webpage suitable for displaying on the user interface device 200.

In some embodiments, the analyzer 134 checks the webpage for one or more suspicious activities if the webpage includes the first part, wherein the one or more suspicious activities are previously reported or new.

Further, when executed, the processor-executable analyzer 134 directs the plurality of circuits 100 to update the database 132 with the obscuring and rendering information.

Turning to FIG. 2 which illustrates a schematic view of the user interface device 200 in accordance with various embodiments of the invention. The user interface device 200 includes parts in common with the plurality of circuits 100. For example, both include a control subsystem comprising at least one processor 102, at least one input/output (I/O) subsystem 104, at least one bus 106 to which the foregoing is coupled. First user interface device 200 includes at least one non-transitory computer or processor-readable storage device(s) 110 coupled to the bus(es) 106. Storage device(s) 110 include, but not limited to, a web browser 230. In some embodiments, storage device(s) 110 include a webpage 232.

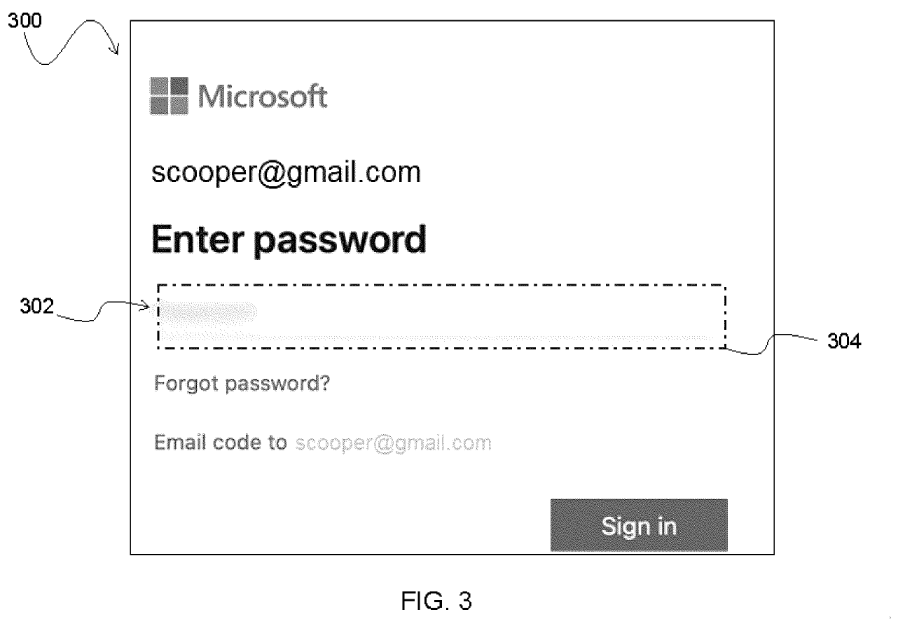

FIG. 3 illustrates an exemplary screenshot 300 including a rendering of a webpage 302. Webpage 302 includes a first part 304 that includes an input field for a user to enter sensitive information such as login password. The plurality of circuits 100 obscures the first part 304 on the webpage 302 by blurring the first part 304 such that the input field for sensitive information is obscured in the rendering and the remaining parts (e.g., fields or sections) of the webpage 302 are rendered.

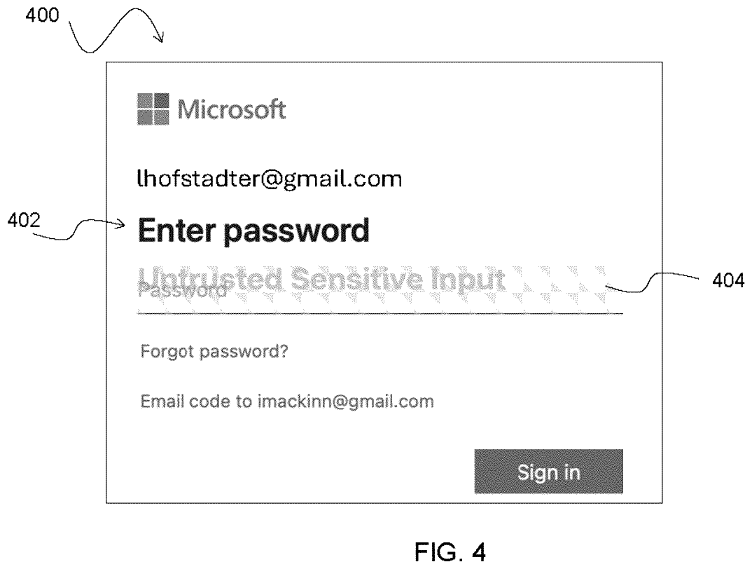

FIG. 4 illustrates an exemplary screenshot 400 including a rendering of a webpage 402 to obscure the first part 404 that includes an input field for a user to enter sensitive information such as login password. The plurality of circuits 100 obscures the first part 404 on the webpage 402 by overlaying or covering the first part 404 such that the input field for sensitive information is obscured in the rendering and the remaining parts (e.g., fields or sections) of the webpage 402 are rendered.

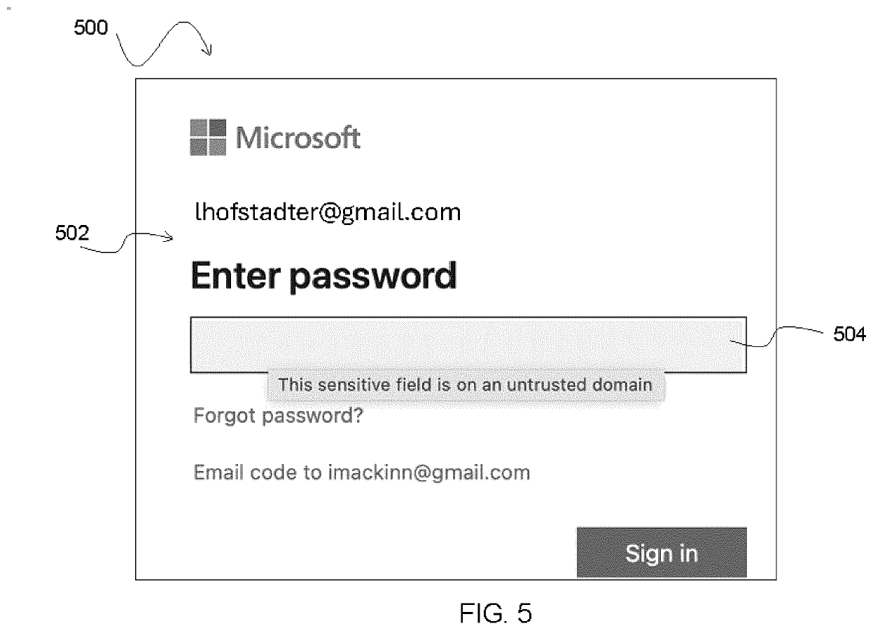

FIG. 5 illustrates an exemplary screenshot 500 including a rendering of a webpage 502. Webpage 502 includes an input field for a user to enter sensitive information such as login password. The system 100 obscures the first part 504 on the webpage 502 by omitting the first part 504 such that the input field for sensitive information is obscured in the rendering and the remaining part (e.g., fields or sections) of the webpage 502 are rendered.

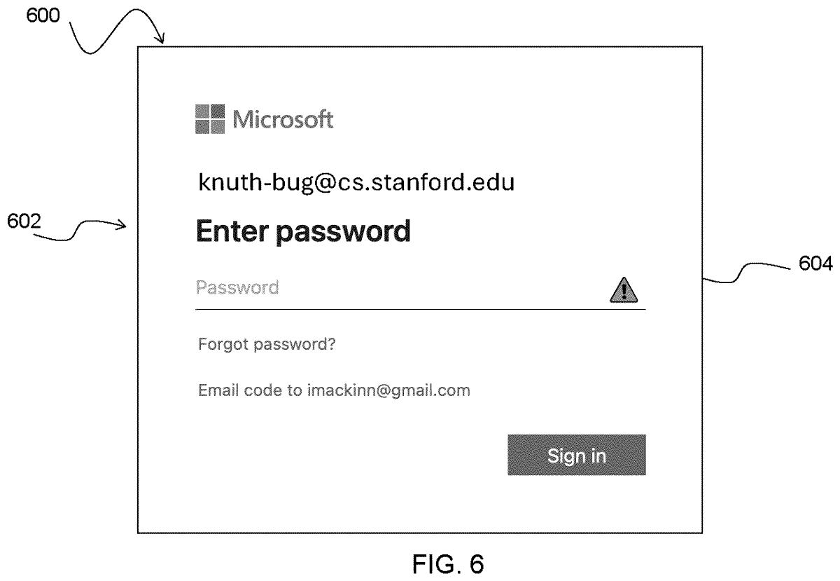

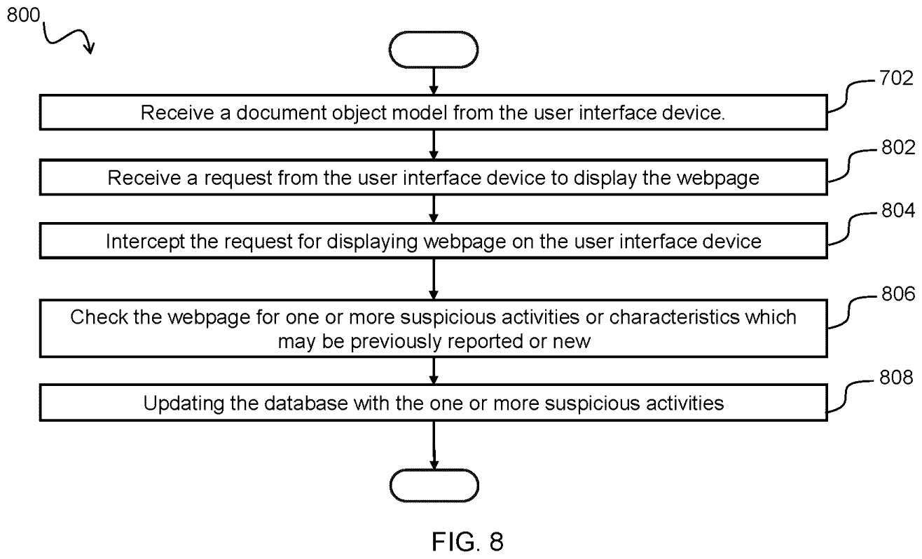

FIG. 6 illustrates an exemplary screenshot 600 including a rendering of a webpage 602. Webpage 602 includes an input field for a user to enter sensitive information such as login password. The system 100 obscures the first part 604 on the webpage 602 by overlaying or covering the first part 604 and/or displaying a warning icon (e.g., triangular in shape). The icon gives a warning about how suspicious the field is, or the site is. In some embodiments, the warning includes an indicator in proximity to the first part which denotes the first part includes a sensitive input field. In some embodiments, the indicator denotes the first part includes a sensitive input field from an untrusted source. For example, the plurality of circuits 100 to detect within the document object model if the webpage contains a sensitive input field or the webpage has suspicious characteristics—see examples described herein in relation to, at least, FIG. 8.

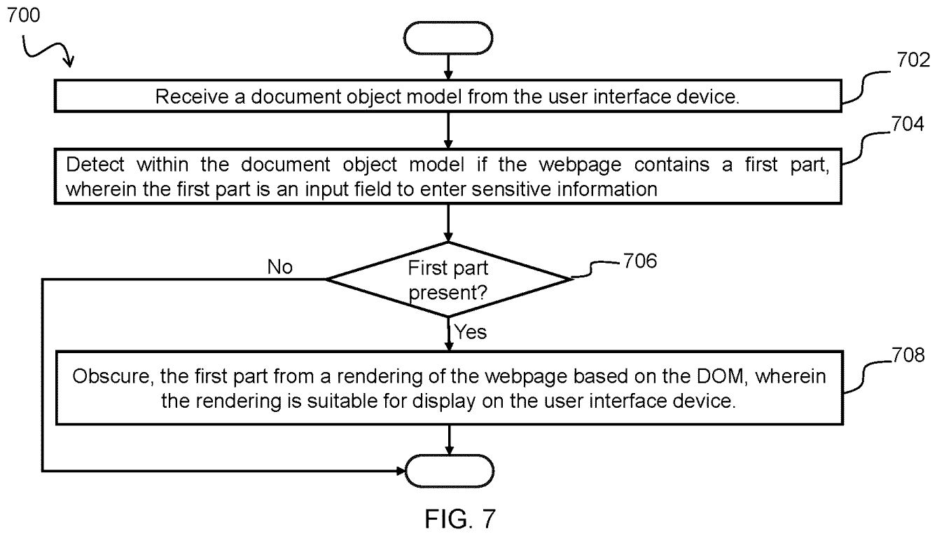

FIG. 7 illustrates an exemplary method 700 for protection from a webpage that may be part of phishing attacks including obscuring the first part containing input field to enter sensitive information. In particular, method 700 is executable by a controller, such as circuitry or at least one hardware processor, such as at least one processor 102. Method 700 as with other methods shown herein may involve other components described herein including those described in including in relation to FIG. 1 through FIG. 6. For example, method 700 may use the plurality of circuits 100. Method 700 is an example of a method for the operation, or improvement in the operation, of protecting the webpages from phishing.

A person skilled in the art will appreciate that other acts may be included, removed, and/or varied or performed in a different order to accommodate alternative implementations. The method 700 may be implemented at the bus(es) 106 through the one or more network or non-network communication channel(s) such as the internet. The method 700 may be performed by the controller (e.g., at least one processor 102) in conjunction with other components or systems as may be obvious to a person skilled in the art. In some embodiments, the controller may, by executing processor-executable instructions, represent analyzer 134, web server 130, database 132, or any such described unit/component in the disclosure. The method 700 initiates at 702.

At 702, the controller receives the document object model (DOM) from the user interface device 200 when the user visits the webpage. For example, the controller receives the DOM when the user device 200 requests to view a webpage. At 702 the controller isn't yet able to determine if the DOM for the webpage includes benign content or maybe a part of a phishing attack.

At 704, the controller checks within the document object model if the webpage contains the first part, wherein the first part is the input field to enter the sensitive information. In some embodiments, the sensitive information is user-sensitive information selected from the group consisting of user login details, password, access credentials, authentication credentials, date of birth, code word, code phrase, banking information, payment information, credit card information, identification information, SIN number, passport number, and locations.

If 706-Yes, the method 700 continues at 708, else (706-No) the method 700 ends until invoked again.

At 708, the controller obscures the first part from a rendering of the webpage based on the DOM, wherein the rendering is suitable for display on the user interface device 200. The obfuscation of the first part includes at least one of blur, overlay, and omission of the first part of the webpage. For example, through processes and examples described herein in relation to, at least, FIG. 3-6 and FIGS. 7-9. For example, when the controller obscures the first part from the rendering of the webpage, the controller adds friction to the workflow which is a beneficial feature in a fraudulent process.

FIG. 8 illustrates another exemplary method 800 according to at least one embodiment of the invention for the operation, or improvement in the operation, of anti-phishing. Method 800 is executable by a controller, such as circuitry or at least one hardware processor, such as at least one processor 102.

Method 800 starts at 702 which may be part of method 700 or another method. At 702, the controller receives the document object model (DOM) from the user interface device 200 when the user visits the webpage.

At 802, the controller receives a request from the user interface device 200 to display the webpage. The webpage could be part of a phishing attack. The request to display the webpage could be implicit or combined with the request for the DOM.

At 804, the controller intercepts the request for displaying the webpage on the user interface device 200. For example, the web server 130 and the analyzer 134 cooperate to intercept the request.

At 806, the controller checks the webpage for one or more suspicious activities or characteristics. The one or more suspicious activities or characteristics were previously reported or are new. Examples of suspicious activities or characteristics are described herein above and include the webpage being for a newly registered domain or cloaking the webpage by rendering different webpage in response to requests coming from different sources.

At 808, the controller updates the database with the one or more suspicious activities.

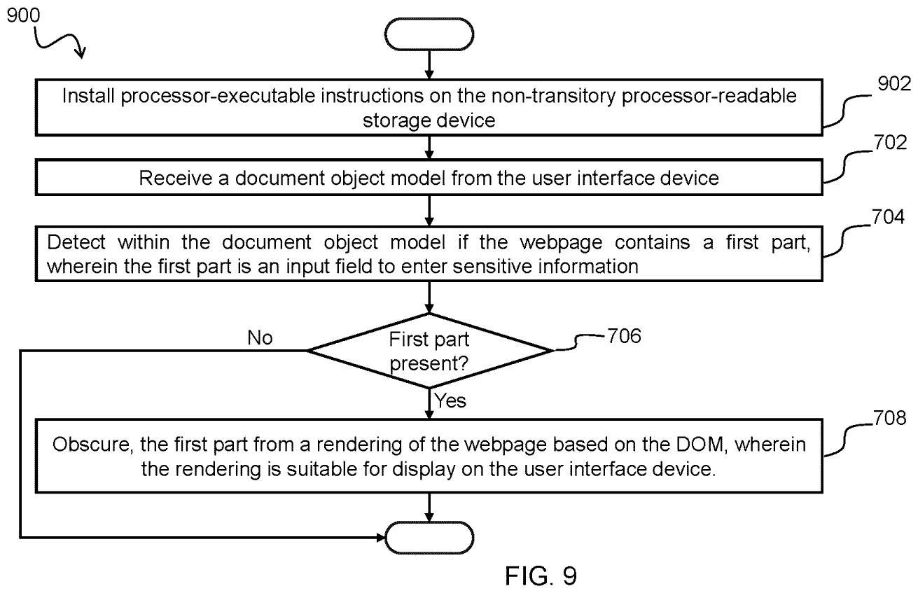

FIG. 9 illustrates a method 900 for obscuring the first part on the webpage as per one embodiment of the invention. Method 900 as with other methods shown herein may involve other components described herein include those described in including in relation to FIG. 1 through FIG. 8. For example, method 900 may use with the plurality of circuits 100.

At 902, processor-executable instructions are installed on the non-transitory processor-readable storage device(s) 110. For example, a user installs the processor-executable instructions as a plugin for their browser. In some implementations, a system administrator installs the processor-executable instructions as part of a security application such as an anti-malware application.

At 702, the controller receives the DOM from the user interface device 200 when the user visits or requestions to visit the webpage.

At 704, the controller checks within the document object model if the webpage contains the first part, wherein the first part is the input field to enter the sensitive information. For example, the user may have been the subject of a sophisticated phishing attack that used social engineering or pretexting to have them follow a link (e.g., manipulated link) to phantom site or webpage including a first part is an input field to enter the sensitive information. The user legitimately believes they need to provide the information but in reality the user is being conned.

If 706-Yes, the method 900 continues at 708, else (706-No) the method 900 ends until invoked again.

At 708, the controller obscures the first part from rendering of the webpage based on the DOM, wherein the rendering is suitable for display on the user interface device 200. To obscure the first part includes at least one of blur, overlay, and omit the first part of the webpage. For example, through processes and examples as shown in FIG. 3-6.

For clarity, various embodiments are included in this description. Each is a numbered example.

Example 1: A method of operation in a system for protection against phishing attacks, the system including at least one processor and a user interface device in communication with the at least one processor, the method comprising: receiving, by the at least one processor, a document object model characterizing a webpage; detecting, by the at least one processor, within the document object model if the webpage contains a first part, wherein the first part is an input field to enter sensitive information; and if the webpage includes the first part, obscuring, by the at least one processor, the first part from a rendering of the webpage based on the document object model, wherein the rendering is suitable for display on the user interface device.

Example 2: The method of example 1 further comprising receiving, by the at least one processor from the user interface device, a request to display the webpage.

Example 3: The method of example 2, further comprising, by the at least one processor, intercepting the request to display the webpage on the user interface device.

Example 4: The method of example 1 further comprising checking, by the at least one processor, the webpage for one or more suspicious activities if the webpage includes the first part, wherein the one or more suspicious activities are previously reported or new.

Example 5: The method of example 1, wherein the document object model includes a language-independent collection of information defining a logical structure of a document and how the document is accessed.

Example 6: The method of example 5, wherein the document object model includes a tree structure where each node in the tree structure is an object representing a part of the document.

Example 7: The method of example 1, wherein the rendering of the webpage comprises converting one or more parts of the document object model into a formatted webpage suitable for displaying on the user interface device.

Example 8: The method of example 1, wherein obscuring the first part from the rendering further comprises rendering, by the at least one processor of the webpage from the document object model with the exception of the first part.

Example 9: The method of example 1, wherein obscuring the first part from the rendering of the webpage based on the document object model further comprises: rendering, by the at least one processor, the webpage, and overlaying, by the at least one processor, the first part which obscures the first part.

Example 10: The method of example 1, wherein obscuring the first part from the rendering of the webpage based on the document object model further comprises: rendering, by the at least one processor, the webpage, and overlaying, by the at least one processor, an indicator in proximity to the first part which denotes the first part includes a sensitive input field.

Example 11: The method of example 1, wherein obscuring the first part from the rendering of the webpage based on the document object model further comprises: rendering, by the at least one processor, the webpage, and blurring, by the at least one processor, the first part which obscures the first part.

Example 12: The method of example 1, wherein obscuring the first part from the rendering of the webpage includes at least one of blurring, overlaying and omitting the first part of the webpage.

Example 13: The method of example 1, wherein the obscuring the first part from the rendering of the webpage provides protection against phishing attacks.

Example 14: The method of example 1, wherein the sensitive information is user-sensitive information selected from the group consisting of user login details, password, access credentials, authentication credentials, date of birth, code word, code phrase, banking information, payment information, credit card information, identification information, SIN number, passport number, and locations.

Example 15: A method of operation in a system including at least one processor, and a non-transitory processor-readable storage device in communication with the at least one processor, the method comprising: installing on the non-transitory processor readable storage device, processor-executable instructions which when executed by the at least one processor, cause the at least one processor to: receive a document object model characterizing a webpage; detect within the document object model if the webpage contains a first part, wherein the first part is an input field to enter sensitive information; and if the webpage includes the first part, obscure the first part from a rendering of the webpage based on the document object model, wherein the rendering is suitable for display on the user interface device.

Example 16: A system for protection against phishing attacks, the system, comprising: a user interface device, wherein the user interface device is processor-based; at least one processor communicatively coupled to the user device; and at least one non-transitory processor-readable storage device communicatively coupled to the at least one processor and which stores processor-executable instructions which, when executed by the at least one processor, cause the at least one processor to: receive a document object model characterizing a webpage, detect within the document object model if the webpage contains a first part, wherein the first part is an input field to input sensitive information, and if the webpage includes the first part, obscure the first part from a rendering of the webpage based on the document object model, wherein the rendering is suitable for display on the user interface device.

Example 17: The system of example 16, wherein the user interface device includes a web browser, and wherein when executed, the processor-executable instructions further cause the at least one processor to: display the webpage in the web browser and intercept a request to display the webpage in the web browser included in the user interface device.

Example 18: The system of example 16, wherein when executed, the processor-executable instructions further cause the at least one processor to check the webpage for one or more suspicious activities if the webpage includes the first part, wherein the one or more suspicious activities are previously reported or new.

1. A method of operation in a system for protection against phishing attacks, the system including at least one processor and a user interface device in communication with the at least one processor, the method comprising:
receiving, by the at least one processor, a document object model characterizing a webpage;
detecting, by the at least one processor, within the document object model if the webpage contains a first part, wherein the first part is an input field to enter sensitive information; and
if the webpage includes the first part, obscuring, by the at least one processor, the first part from a rendering of the webpage based on the document object model, wherein the rendering is suitable for display on the user interface device.

2. The method of claim 1 further comprising receiving, by the at least one processor from the user interface device, a request to display the webpage.

3. The method of claim 2, further comprising, by the at least one processor, intercepting the request to display the webpage on the user interface device.

4. The method of claim 1 further comprising checking, by the at least one processor, the webpage for one or more suspicious activities if the webpage includes the first part, wherein the one or more suspicious activities are previously reported or new.

5. The method of claim 1, wherein the document object model includes a language-independent collection of information defining a logical structure of a document and how the document is accessed.

6. The method of claim 5, wherein the document object model includes a tree structure where each node in the tree structure is an object representing a part of the document.

7. The method of claim 1, wherein the rendering of the webpage comprises converting one or more parts of the document object model into a formatted webpage suitable for displaying on the user interface device.

8. The method of claim 1, wherein obscuring the first part from the rendering further comprises rendering, by the at least one processor, of the webpage from the document object model with the exception of the first part.

9. The method of claim 1, wherein obscuring the first part from the rendering of the webpage based on the document object model further comprises:
rendering, by the at least one processor, the webpage, and
overlaying, by the at least one processor, the first part which obscures the first part.

10. The method of claim 1, wherein obscuring the first part from the rendering of the webpage based on the document object model further comprises:
rendering, by the at least one processor, the webpage, and
overlaying, by the at least one processor, an indicator in proximity to the first part which denotes the first part includes a sensitive input field.

11. The method of claim 1, wherein obscuring the first part from the rendering of the webpage based on the document object model further comprises:
rendering, by the at least one processor, the webpage, and
blurring, by the at least one processor, the first part which obscures the first part.

12. The method of claim 1, wherein obscuring the first part from the rendering of the webpage includes at least one of blurring, overlaying and omitting the first part of the webpage.

13. The method of claim 1, wherein the obscuring the first part from the rendering of the webpage provides protection against phishing attacks.

14. The method of claim 1, wherein the sensitive information is user-sensitive information selected from the group consisting of user login details, password, access credentials, authentication credentials, date of birth, code word, code phrase, banking information, payment information, credit card information, identification information, SIN number, passport number, and locations.

15. A method of operation in a system including at least one processor, and a non-transitory processor-readable storage device in communication with the at least one processor, the method comprising:
installing on the non-transitory processor readable storage device, processor-executable instructions which when executed by the at least one processor, cause the at least one processor to:
receive a document object model characterizing a webpage;
detect within the document object model if the webpage contains a first part, wherein the first part is an input field to enter sensitive information; and
if the webpage includes the first part, obscure the first part from a rendering of the webpage based on the document object model,
wherein the rendering is suitable for display on the user interface device.

16. A system for protection against phishing attacks, the system, comprising:
a user interface device, wherein the user interface device is processor-based;
at least one processor communicatively coupled to the user device; and
at least one non-transitory processor-readable storage device communicatively coupled to the at least one processor and which stores processor-executable instructions which, when executed by the at least one processor, cause the at least one processor to:
receive a document object model characterizing a webpage,
detect within the document object model if the webpage contains a first part, wherein the first part is an input field to input sensitive information, and
if the webpage includes the first part, obscure the first part from a rendering of the webpage based on the document object model, wherein the rendering is suitable for display on the user interface device.

17. The system of claim 16, wherein the user interface device includes a web browser, and wherein when executed, the processor-executable instructions further cause the at least one processor to:
display the webpage in the web browser, and
intercept a request to display the webpage in the web browser included in the user interface device.

18. The system of claim 16, wherein when executed, the processor-executable instructions further cause the at least one processor to check the webpage for one or more suspicious activities if the webpage includes the first part, wherein the one or more suspicious activities are previously reported or new.
